(19) United States
(12) Patent Application Publication
(10) Pub. No.: US 2017/0275117 A1
(43) Pub. Date: Sep. 28, 2017

(54) MEANDERING CORRECTION APPARATUS, BASE MATERIAL PROCESSING APPARATUS AND MEANDERING CORRECTION METHOD

(71) Applicant: SCREEN HOLDINGS CO., LTD., Kyoto-shi (JP)

(72) Inventors: Hiroyuki KAJIYA, Kyoto (JP); Shinji HAYASHI, Kyoto (JP)

(21) Appl. No.: 15/457,726

(22) Filed: Mar. 13, 2017

(30) Foreign Application Priority Data
Mar. 23, 2016 (JP) 2016-058010

(51) Int. Cl. B65H 23/038; B65H 23/02; B65H 20/02; B41J 13/26

(52) U.S. Cl. CPC B65H 23/038; B41J 13/26; B65H 23/0204; B65H 20/02; B65H 2801/06

(57) ABSTRACT

A meandering correction apparatus includes a transport mechanism, an orientation measurement part, a Young's modulus calculation part, a meandering prediction part and a meandering correction part. The transport mechanism transports an elongated strip-shaped base material in a longitudinal direction thereof along a transport path. The orientation measurement part measures fiber orientations of the base material in respective measurement regions on the transport path, the measurement regions being different in widthwise position from each other. The Young's modulus calculation part calculates Young's moduli of the base material for the respective measurement regions, based on the fiber orientations. The meandering prediction part predicts subsequent meandering of the base material, based on the Young's moduli, to output meandering prediction information. The meandering correction part corrects the widthwise position of the base material, based on the meandering prediction information. The meandering correction is made based on the fiber orientations of the base material. Thus, the widthwise position of the base material is corrected without depending on only edge sensors.

### BACKGROUND OF THE INVENTION

Field of the Invention

The present invention relates to a meandering correction technique for correcting the meandering of an elongated strip-shaped base material during the transport of the base material.

Description of the Background Art

A base material processing apparatus which performs a variety of processes on an elongated strip-shaped base material while transporting the base material in a longitudinal direction thereof by means of a plurality of rollers has heretofore been known. In such a base material processing apparatus, the base material is transported while meandering in some cases because the base material is moved out of its ideal position in a width direction thereof. To prevent this, a meandering correction apparatus for suppressing such meandering is incorporated in the base material processing apparatus.

A conventional meandering correction apparatus is disclosed, for example, in Japanese Patent Application Laid-Open No. 2009-269745. The meandering correction apparatus disclosed in Japanese Patent Application Laid-Open No. 2009-269745 includes edge sensors for detecting the position of edges of a base material. Based on signals from the edge sensors, the meandering correction apparatus corrects the widthwise position (position as seen in the width direction) of the base material.

In general, the widthwise edges of the base material are not perfectly straight. For example, when the base material is cut with a disk-shaped cutter, the shape of the widthwise edges of the base material has slight undulations corresponding to the rotation period of the cutter. The edge sensors also detect such a shape of the edges of the base material. In that case, the meandering correction apparatus makes an unnecessary correction, based on the shape of the edges of the base material.

### SUMMARY OF THE INVENTION

It is therefore an object of the present invention to provide a technique capable of correcting the widthwise position of a base material without depending on only edge sensors.

A first aspect of the present invention is intended for a meandering correction apparatus comprising: a transport mechanism for transporting an elongated strip-shaped base material in a longitudinal direction thereof along a transport path; an orientation measurement part for measuring fiber orientations of the base material in respective measurement regions on the transport path, the measurement regions being different in widthwise position from each other; a Young's modulus calculation part for calculating Young's moduli of the base material for the respective measurement regions, based on the fiber orientations; a meandering prediction part for predicting subsequent meandering of the base material, based on the Young's moduli, to output meandering prediction information; and a meandering correction part for correcting the widthwise position of the base material, based on the meandering prediction information.

A second aspect of the present invention is intended for a method of correcting a widthwise position of an elongated strip-shaped base material transported along a transport path to correct meandering of the base material. The method comprises the steps of: a) measuring fiber orientations of the base material in respective measurement regions on the transport path, the measurement regions being different in widthwise position from each other; b) calculating Young's moduli of the base material for the respective measurement regions, based on the fiber orientations; c) predicting subsequent meandering of the base material, based on the Young's moduli, to output meandering prediction information; and d) correcting the widthwise position of the base material, based on the meandering prediction information.

According to the first and second aspects of the present invention, the widthwise position of the base material is corrected without depending on only edge sensors.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the configuration of a printing apparatus;

FIG. 2 is a view of an example of a meandering correction part;

FIG. 3 is a block diagram showing connections between a controller and components in the printing apparatus;

FIG. 4 is a view conceptually showing a relationship between a fiber orientation distribution of printing paper, tension applied to the printing paper and the stretchability of the printing paper;

FIG. 5 is a flow diagram showing a procedure for a meandering correction process;

FIG. 6 is a view showing measurement regions for an orientation measurement part;

FIG. 7 is a flow diagram showing a procedure for a Young's modulus calculation process; and

FIG. 8 is a flow diagram showing another procedure for the Young's modulus calculation process according to a modification.

### DESCRIPTION OF THE PREFERRED EMBODIMENTS

A preferred embodiment according to the present invention will now be described with reference to the drawings. A direction in which printing paper 9 is transported is referred to as a “transport direction”, and a horizontal direction orthogonal to the transport direction is referred to as a “width direction” hereinafter.

<1. Configuration of Printing Apparatus>

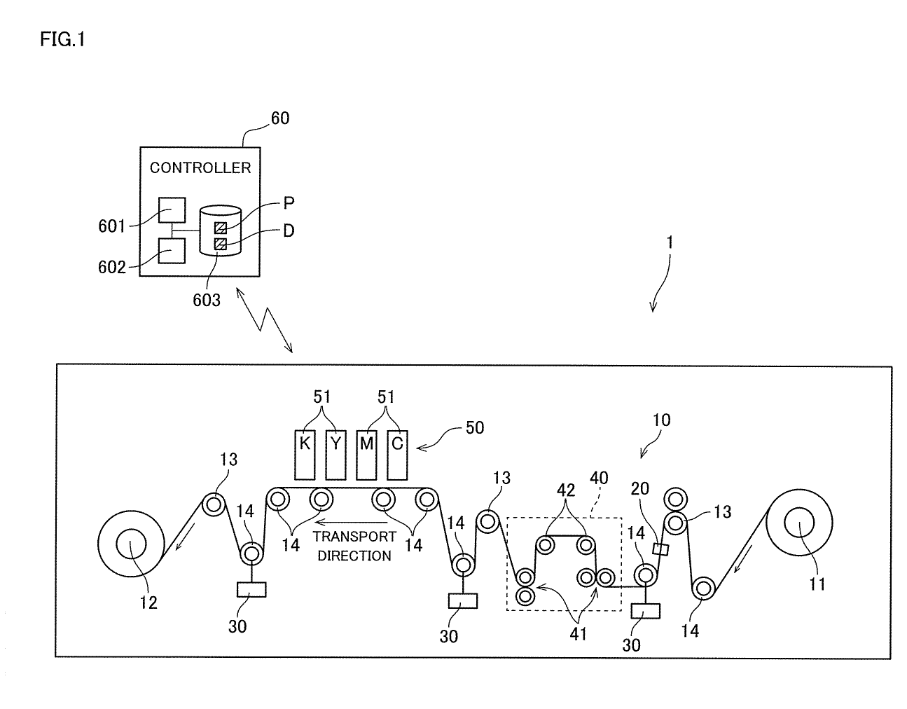

FIG. 1 is a diagram showing the configuration of a printing apparatus 1 according to one preferred embodiment of the present invention. This printing apparatus 1 is an apparatus for recording an image on a surface of the printing paper 9 which is an elongated strip-shaped base material, based on inkjet technology, while transporting the printing paper 9 in a longitudinal direction thereof. As shown in FIG. 1, the printing apparatus 1 includes a transport mechanism 10, an orientation measurement part 20, tension measurement parts 30, a meandering correction part 40, an image recording part 50 and a controller 60.

The transport mechanism 10 is a mechanism for transporting the printing paper 9 along a predetermined transport path. The transport mechanism 10 according to the present preferred embodiment includes an unwinder 11, a winder 12 and a plurality of transport rollers 13 and 14. A motor (not shown) serving as a power source is coupled to each of the unwinder 11 and the winder 12. The transport rollers 13 and 14 include drive rollers 13 rotated automatically by the power of motors, and follower rollers 14 not coupled to any motor but rotated in accordance with the motion of the printing paper 9.

The transport rollers 13 and 14 constitute the transport path of the printing paper 9. Each of the transport rollers 13 and 14 rotates about a horizontal axis to guide the printing paper 9 downstream along the transport path. The printing paper 9 comes in contact with the transport rollers 13 and 14, so that tension is applied to the printing paper 9.

Each of the unwinder 11, the winder 12 and the drive rollers 13 rotates when the controller 60 drives the motor coupled to each of the unwinder 11, the winder 12 and the drive rollers 13. Thus, the printing paper 9 is unwound from the unwinder 11 and transported via the transport rollers 13 and 14 to the winder 12.

The orientation measurement part 20 is a sensor for measuring a fiber orientation of the printing paper 9 on the transport path of the printing paper 9. In the instance shown in FIG. 1, the orientation measurement part 20 is disposed downstream from the unwinder 11 and upstream from the meandering correction part 40 as seen along the transport path. A sensor which directs light having directivity toward the surface of the printing paper 9 to measure the fiber orientation, based on the intensity distribution of reflected light (scattered light) therearound, for example, is used for the orientation measurement part 20. However, the orientation measurement part 20 may use other techniques to measure the fiber orientation of the printing paper 9. It is preferable that the orientation measurement part 20 is capable of inspecting the fiber orientation in a non-contacting manner without applying an external force to the printing paper 9.

The tension measurement parts 30 are sensors for measuring the tension applied to the printing paper 9 on the transport path of the printing paper 9. In the instance shown in FIG. 1, there are disposed three tension measurement parts 30: one between the orientation measurement part 20 and the meandering correction part 40; one between the meandering correction part 40 and the image recording part 50; and one between the image recording part 50 and the winder 12. However, the printing apparatus 1 may include one or two tension measurement parts 30 or not less than four tension measurement parts 30. For example, a mechanism which measures a load applied to the rotary shaft of each of the follower rollers 14 by means of a load cell is used for the tension measurement parts 30.

The meandering correction part 40 includes a mechanism for correcting the widthwise position (position as seen in the width direction) of the printing paper 9. In the instance shown in FIG. 1, the meandering correction part 40 is disposed downstream from the orientation measurement part 20 and upstream from the image recording part 50 as seen along the transport path.

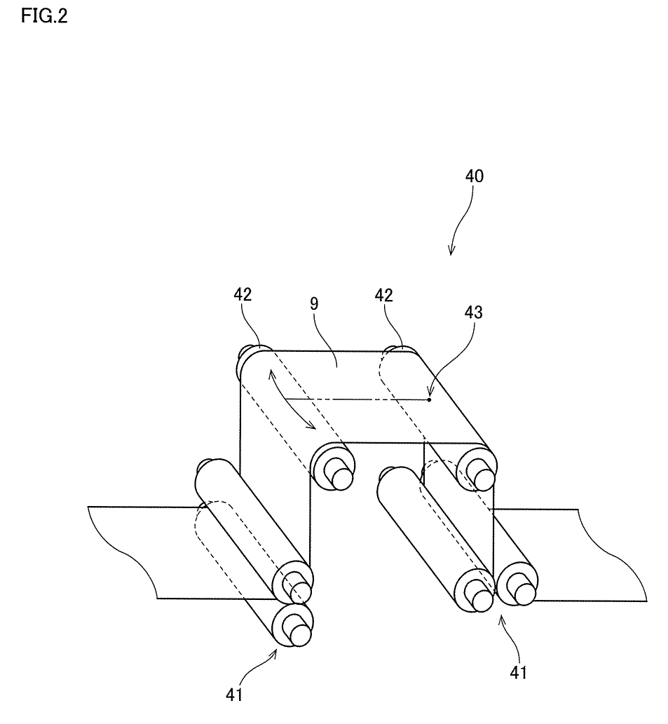

FIG. 2 is a view showing an example of the meandering correction part 40. The meandering correction part 40 shown in FIG. 2 includes a pair of guide rollers 42 between two pairs of fixed rollers 41. While being in contact with the printing paper 9, the two pairs of fixed rollers 41 and the pair of guide rollers 42 rotate to guide the printing paper 9 downstream. A moving mechanism not shown is connected to the pair of guide rollers 42. When the moving mechanism is put into operation, the pair of guide rollers 42 pivots in the width direction of the printing paper 9 about a pivot 43. This allows the widthwise displacement of the printing paper 9.

However, the meandering correction part according to the present invention is not limited to that having the structure shown in FIG. 2. The meandering correction part may be configured, for example, to incline the guide rollers to cause the widthwise displacement of the printing paper 9. Alternatively, the meandering correction part may be configured to cause the widthwise displacement of recording heads 51 to be described later, thereby correcting the widthwise position of the printing paper 9 relative to the recording heads 51.

The image recording part 50 includes a mechanism for ejecting ink droplets toward the printing paper 9 transported by the transport mechanism 10. In the instance shown in FIG. 1, the image recording part 50 is disposed downstream from the orientation measurement part 20 and the meandering correction part 40 and upstream from the winder 12 as seen along the transport path.

The image recording part 50 according to the present preferred embodiment includes four recording heads 51. The four recording heads 51 are disposed over the transport path of the printing paper 9 and spaced apart from each other in the transport direction. Each of the recording heads 51 includes nozzles arranged parallel to the width direction of the printing paper 9. The four recording heads 51 eject ink droplets of four respective colors, i.e. cyan (C), magenta (M), yellow (Y) and black (K), which serve as color components of a color image from the nozzles toward an upper surface of the printing paper 9. Thus, the color image is recorded on the upper surface of the printing paper 9.

The image recording part 50 according to the present preferred embodiment is what is called a one-pass type recording part. Specifically, the four recording heads 51 do not move back and forth in the width direction. The image recording part 50 records an image on the upper surface of the printing paper 9 by ejecting the ink droplets from the recording heads 51 while the printing paper 9 passes under the recording heads 51 only once.

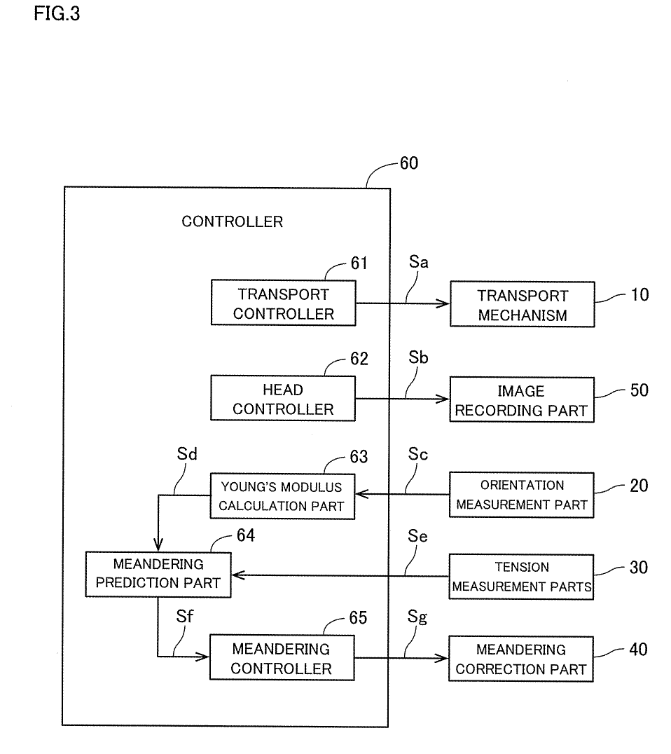

The controller 60 is a part for controlling the operations of the components in the printing apparatus 1. As conceptually shown in FIG. 1, the controller 60 is formed by a computer including an arithmetic processor 601 such as a CPU, a memory 602 such as a RAM and a storage part 603 such as a hard disk drive. FIG. 3 is a block diagram showing connections between the controller 60 and the components in the printing apparatus 1. As shown in FIG. 3, the controller 60 is connected to the transport mechanism 10, the orientation measurement part 20, the tension measurement parts 30, the meandering correction part 40 and the image recording part 50 mentioned above for communication therewith.

The controller 60 temporarily reads a computer program P and data D that are stored in the storage part 603 onto the memory 602. The arithmetic processor 601 performs arithmetic processing based on the computer program P and the data D, so that the controller 60 controls the operations of the components in the printing apparatus 1. Thus, the printing process and a meandering correction process to be described later proceed in the printing apparatus 1.

As conceptually shown in FIG. 3, the controller 60 includes a transport controller 61, a head controller 62, a Young's modulus calculation part 63, a meandering prediction part 64 and a meandering controller 65. The computer serving as the controller 60 operates in accordance with the computer program P, whereby the functions of these components are implemented.

The transport controller 61 controls the operation of transporting the printing paper 9 by means of the transport mechanism 10. Specifically, the transport controller 61 outputs a driving instruction signal Sa to the motor connected to each of the unwinder 11, the winder 12 and the drive rollers 13. This drives the motors at specified rpm (the number of revolutions). When the motors are driven, the printing paper 9 is transported along the transport path by the rotation of the unwinder 11, the winder 12 and the drive rollers 13.

The head controller 62 controls the operation of ejecting the ink droplets in each of the four recording heads 51. Based on submitted image data, the head controller 62 outputs an ejection instruction signal Sb to the four recording heads 51. The ejection instruction signal Sb includes information indicating nozzles from which the ink droplets are to be ejected, the size of the ink droplets, and the ejection timing of the ink droplets. Each of the recording heads 51 ejects the ink droplets having the size specified by the ejection instruction signal Sb from the nozzles specified by the ejection instruction signal Sb according to the timing specified by the ejection instruction signal Sb. Thus, an image corresponding to the image data is formed on the upper surface of the printing paper 9.

The Young's modulus calculation part 63 calculates a Young's modulus for each region. The Young's modulus indicates a relationship between the tension applied to the printing paper 9 and the amount of stretch of the printing paper 9 that is an elastic body. The aforementioned orientation measurement part 20 outputs fiber orientation information Sc that is a measurement result to the Young's modulus calculation part 63. Based on the obtained fiber orientation information Sc, the Young's modulus calculation part 63 calculates a Young's modulus Sd of the printing paper 9. The calculated Young's modulus Sd is inputted from the Young's modulus calculation part 63 to the meandering prediction part 64.

The meandering prediction part 64 predicts meandering that will occur in the printing paper 9 transported by the transport mechanism 10. Each of the aforementioned tension measurement parts 30 outputs tension information Se that is a measurement result to the meandering prediction part 64. Based on the Young's modulus Sd calculated by the Young's modulus calculation part 63 and the tension information Se measured by the tension measurement parts 30, the meandering prediction part 64 predicts the meandering that will occur thereafter in the printing paper 9. Then, the meandering prediction part 64 outputs meandering prediction information Sf indicative of a result of prediction to the meandering controller 65.

The meandering controller 65 controls the operation of the meandering correction part 40. Based on the meandering prediction information Sf provided from the meandering prediction part 64, the meandering controller 65 calculates a correction amount in the meandering correction part 40. Then, the meandering controller 65 outputs a correction instruction signal Sg indicative of the calculated correction amount to the meandering correction part 40. Based on the correction instruction signal Sg, the meandering correction part 40 pivots the guide rollers 42. Thus, the widthwise position of the printing paper 9 is corrected.

In this manner, the printing apparatus 1 includes a meandering correction apparatus comprising the transport mechanism 10, the orientation measurement part 20, the tension measurement parts 30, the meandering correction part 40 and the controller 60.

<2. Meandering Correction>

Next, the meandering correction in the printing apparatus 1 will be described in further detail.

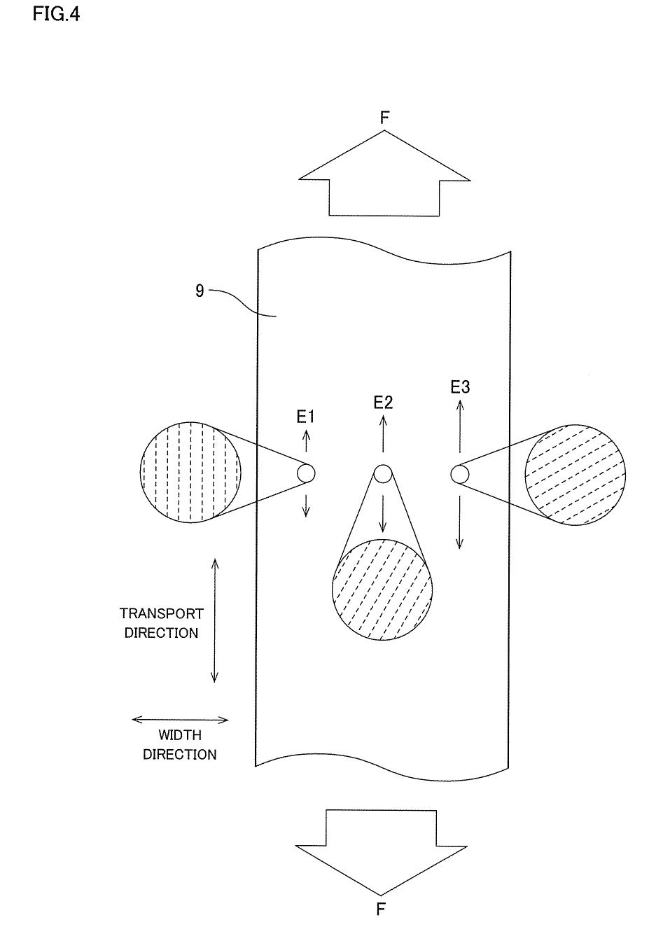

FIG. 4 is a view conceptually showing a relationship between a fiber orientation distribution of the printing paper 9, tension F applied to the printing paper 9 and the stretchability of the printing paper 9. The fiber orientation of the printing paper 9 is not necessarily constant. As shown in FIG. 4, there are hence cases in which the fiber orientation differs depending on the widthwise position of the printing paper 9. On the other hand, the tension F is constantly applied to the printing paper 9 transported by the transport mechanism 10 in a direction substantially parallel to the transport direction.

When the fiber orientation and the direction of the tension F are parallel to each other, the printing paper 9 is less prone to stretch in the transport direction due to the tension F, as indicated by the reference character El in FIG. 4. That is, the Young's modulus of the printing paper 9 in the transport direction is increased. However, as the angle between the fiber orientation and the direction of the tension F increases (approaches 90 degrees), the printing paper 9 is more prone to stretch in the transport direction due to the tension F, as indicated by the reference characters E2 and E3 in FIG. 4. That is, the Young's modulus of the printing paper 9 in the transport direction is decreased.

Thus, even when the tension F is applied uniformly to the printing paper 9, the unevenness of the fiber orientation of the printing paper 9 causes the printing paper 9 to stretch in the transport direction differently depending on the widthwise position of the printing paper 9. In this manner, the deformation of the printing paper 9 resulting from the unevenness of the fiber orientation becomes a factor responsible for the meandering. The printing apparatus 1 makes in-line measurements of the fiber orientation in different portions of the printing paper 9 to correct the meandering expected to result from the fiber orientation by means of the meandering correction part 40.

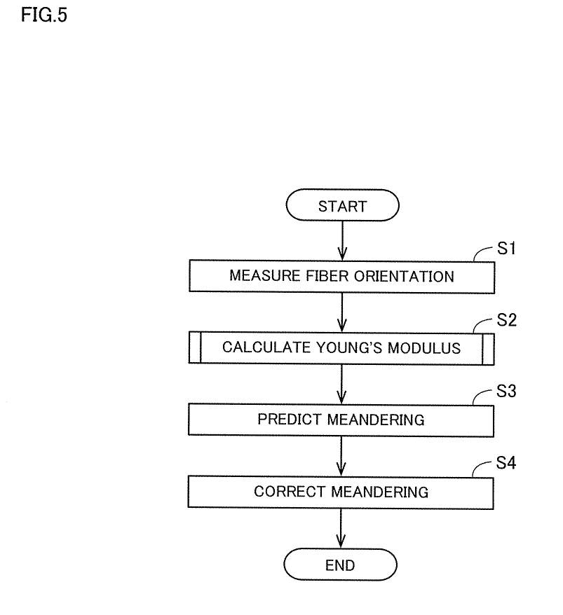

FIG. 5 is a flow diagram showing a procedure for the meandering correction process in the printing apparatus 1. In this printing apparatus 1, the meandering correction process shown in FIG. 5 is performed repeatedly at predetermined time intervals (e.g., at time intervals of one second) when the printing paper 9 is transported.

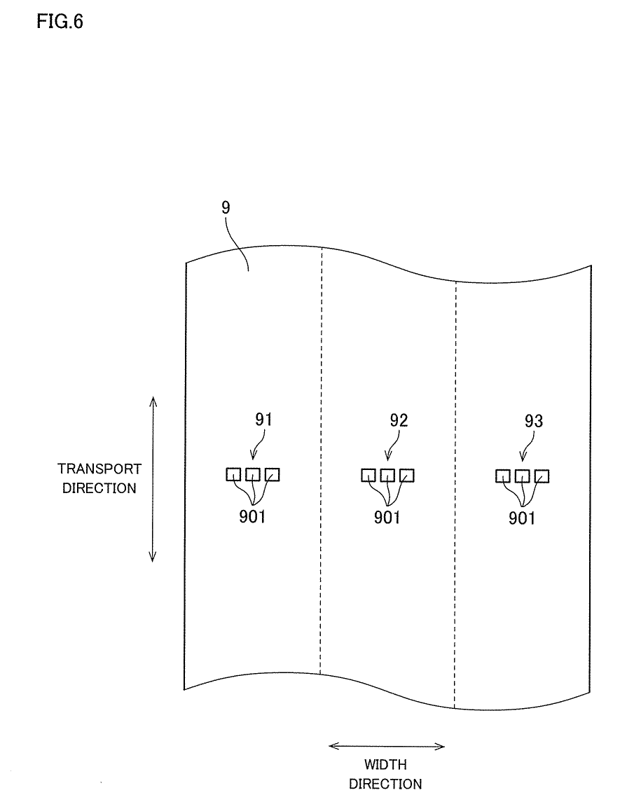

When the transport of the printing paper 9 is started, the orientation measurement part 20 starts measuring a fiber orientation of the printing paper 9 (Step S1). FIG. 6 is a view showing measurement regions for the orientation measurement part 20. As shown in FIG. 6, the orientation measurement part 20 according to the present preferred embodiment measures fiber orientations of the printing paper 9 in three respective measurement regions 91, 92 and 93. The three measurement regions 91, 92 and 93 differ in widthwise position from each other.

Of the three measurement regions 91, 92 and 93, the middle measurement region 92 is preferably positioned in the middle of the printing paper 9 as seen in the width direction. Of the three measurement regions 91, 92 and 93, the two remaining measurement regions 91 and 93 are preferably positioned on opposite sides of the middle measurement region 92 as seen in the width direction and spaced equidistantly apart from the middle measurement region 92 as seen in the width direction. However, there are cases in which it is difficult to precisely measure the fiber orientation near the opposite widthwise edges of the printing paper 9 under the influence of cutting or deformation. For this reason, the two measurement regions 91 and 93 are preferably positioned in inwardly spaced relation from the opposite widthwise edges of the printing paper 9. For example, the three measurement regions 91, 92 and 93 may be disposed near the middle of three respective blocks into which the printing paper 9 is divided in the width direction.

As shown in FIG. 6, each of the three measurement regions 91, 92 and 93 includes a plurality of measurement positions 901. The measurement positions 901 differ in widthwise position from each other. In the instance shown in FIG. 6, each measurement region includes three measurement positions 901. However, each measurement region may include one or two measurement positions 901 or not less than four measurement positions 901. The orientation measurement part 20 measures fiber orientations of the printing paper 9 in the respective measurement positions 901. Thus, the fiber orientation (a fiber orientation angle with respect to the transport direction) in each of the measurement positions 901 is acquired. Then, the orientation measurement part 20 sends the acquired fiber orientation information Sc to the Young's modulus calculation part 63 of the controller 60. The fiber orientation information Sc includes information about the fiber orientation in each of the measurement positions 901.

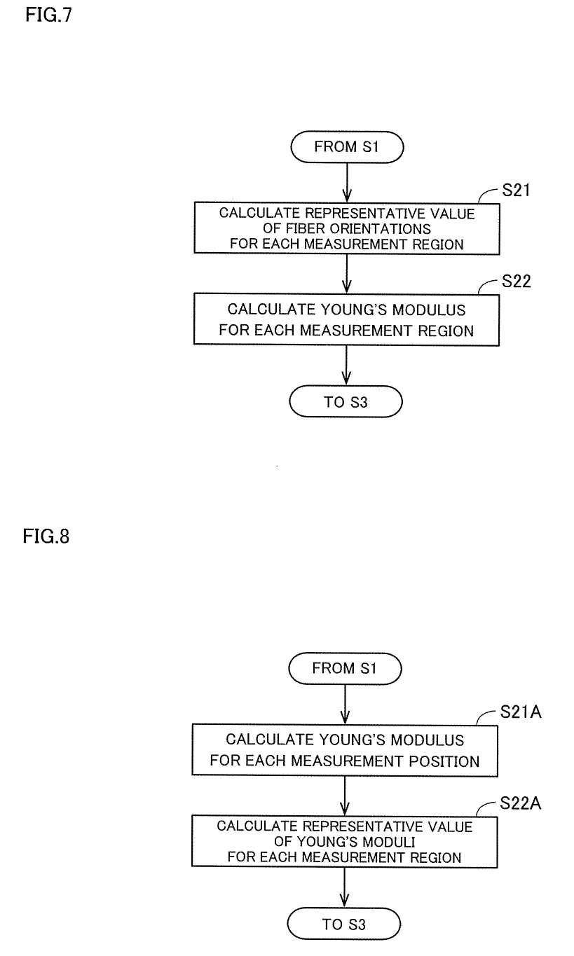

Next, the Young's modulus calculation part 63 calculates the Young's modulus Sd in each of the measurement regions 91, 92 and 93 of the printing paper 9, based on the fiber orientation information Sc inputted from the orientation measurement part 20 (Step S2). FIG. 7 is a flow diagram showing the details of Step S2. The Young's modulus calculation part 63 according to the present preferred embodiment initially calculates a representative value of the fiber orientations for each of the measurement regions 91, 92 and 93, based on the fiber orientations in the respective measurement positions 901 (Step S21). For example, the average value of the orientation angles in the measurement positions 901 included in each measurement region is used as the representative value of the fiber orientations for each measurement region. The representative value of the fiber orientations, however, may be a value calculated by other calculation methods or statistical techniques.

Subsequently, the Young's modulus calculation part 63 calculates the Young's modulus Sd in the transport direction for each of the measurement regions 91, 92 and 93 of the printing paper 9, based on the representative value of the fiber orientations (Step S22). A conversion equation or table data indicative of a correspondence between the fiber orientations and the Young's moduli is stored in the controller 60. Based on the conversion equation or table data, the Young's modulus calculation part 63 calculates the Young's modulus corresponding to the representative value of the fiber orientations. As the fiber orientation is closer to parallel to the transport direction of the printing paper 9, the calculated Young's modulus Sd increases. As the fiber orientation is closer to perpendicular to the transport direction of the printing paper 9, the calculated Young's modulus Sd decreases.

As mentioned above, the meandering correction process is performed repeatedly at predetermined time intervals. Thus, the Young's modulus Sd of the printing paper 9 is calculated at predetermined spaced intervals in the transport direction in Step S2.

Referring again to FIG. 5, after the Young's modulus Sd is calculated for each of the measurement regions 91, 92 and 93, the meandering prediction part 64 then predicts the meandering of the printing paper 9, based on the Young's modulus Sd and the tension information Se provided from the tension measurement parts 30 (Sep S3). Specifically, the meandering prediction part 64 calculates the stretch of the printing paper 9 in the transport direction for each of the measurement regions 91, 92 and 93, based on the Young's modulus Sd and the tension information Se. When the printing paper 9 stretches in the transport direction differently depending on the widthwise position, the direction of the center line of the printing paper 9 is varied. The meandering prediction part 64 calculates a variation in the direction of the center line to predict the meandering that will occur in the printing paper 9 in the case where no meandering correction is made. Then, the meandering prediction part 64 outputs the meandering prediction information Sf indicative of the prediction result to the meandering controller 65.

Thereafter, the meandering controller 65 controls the operation of the meandering correction part 40, based on the meandering prediction information Sf provided from the meandering prediction part 64 (Step S4). In this step, the meandering controller 65 calculates the correction amount so as to cancel out the meandering predicted in the meandering prediction information Sf. Then, the meandering controller 65 outputs the correction instruction signal Sg indicative of the calculated correction amount to the meandering correction part 40. The meandering correction part 40 pivots the guide rollers 42, based on the correction instruction signal Sg. Thus, the widthwise position of the printing paper 9 is corrected.

The aforementioned correction instruction signal Sg is preferably calculated so as to cancel the widthwise misregistration of the printing paper 9 especially in the image recording part 50 in the entire transport path. At this time, the correction amount is preferably determined so that the widthwise position of the printing paper 9 approaches an ideal position in the image recording part 50 in consideration for the transport distance of the printing paper 9 from the meandering correction part 40 to the image recording part 50 and the first order lag characteristics of the meandering correction.

In this printing apparatus 1, as described hereinabove, the fiber orientations of the printing paper 9 are measured, and the meandering correction of the printing paper 9 is made, based on the measured fiber orientations. Thus, the widthwise position of the printing paper 9 is corrected without depending on edge sensors. Therefore, when the edges of the printing paper 9 are not perfectly straight, the meandering correction of the printing paper 9 is made without being swayed by the shape of the edges of the printing paper 9.

<3. Modifications>

While the one preferred embodiment according to the present invention has been described hereinabove, the present invention is not limited to the aforementioned preferred embodiment.

FIG. 8 is a flow diagram showing another procedure for the process of calculating the Young's modulus Sd according to a modification. In the instance shown in FIG. 8, the Young's modulus calculation part 63 initially calculates the Young's modulus in the transport direction for each of the measurement positions 901, based on the measured fiber orientations (Step S21A). That is, the Young's modulus calculation part 63 calculates the Young's modulus for each of the measurement positions 901 in one measurement region. Then, based on the calculated Young's moduli, the Young's modulus calculation part 63 calculates a representative value of the Young's moduli for each of the measurement regions 91, 92 and 93 (Step S22A). For example, the average value of the Young's moduli is used as the representative value of the Young's moduli for each measurement region. The representative value of the Young's moduli, however, may be a value calculated by other calculation methods or statistical techniques. Thereafter, the meandering prediction part 64 predicts the meandering of the printing paper 9, based on the representative value of the Young's moduli provided from the Young's modulus calculation part 63 and the tension information Se provided from the tension measurement parts 30.

For multi-point measurement of the fiber orientations in each measurement region, the procedure as shown in FIG. 7 may be used in which the Young's modulus for each measurement region is calculated based on the representative value of the fiber orientations obtained by multi-point measurement or the procedure as shown in FIG. 8 may be used in which the representative value of the Young's moduli for each measurement region is determined after the conversion of the individual fiber orientations obtained by multi-point measurement into the Young's moduli.

In the aforementioned preferred embodiment, the three measurement regions are provided for the orientation measurement part. However, two or not less than four measurement regions may be provided for the orientation measurement part. The measurement regions need not necessarily be disposed in the same position as seen in the transport direction. For example, the measurement regions may be arranged in a staggered configuration in the width direction of the printing paper 9. Also, the orientation measurement part may measure the fiber orientations of the printing paper in a plurality of widthwise positions while moving in the width direction.

The orientation measurement part may be disposed on either of the front and back surface sides of the printing paper. However, when a coating is applied to one of the surfaces of the printing paper, it is difficult to precisely measure the fiber orientations on that surface. In that case, it is preferable that the orientation measurement part is disposed on the other surface side to which no coating is applied.

In the aforementioned preferred embodiment, edge sensors are completely eliminated from the printing apparatus. However, an edge sensor may be used together with the meandering correction apparatus according to the present invention. Specifically, the meandering correction apparatus according to the present invention may correct the meandering of the printing paper in consideration for both the position of the edges of the printing paper measured by the edge sensor and the meandering of the printing paper predicted from the fiber orientations.

The image recording part according to the aforementioned preferred embodiment includes the four recording heads. However, the number of recording heads in the image recording part may be in the range of one to three or not less than five. For example, the image recording part may further include a recording head for ejecting an ink of a spot color in addition to the four recording heads for ejecting inks of C, M, Y and K.

The printing paper is used as the base material in the aforementioned preferred embodiment. However, the base material to be subjected to the meandering correction in the present invention is not necessarily limited to paper but may include base materials (e.g., nonwoven fabric) other than paper which have a fiber orientation.

The printing apparatus which ejects ink toward the surface of the base material has been described in the aforementioned preferred embodiment. That is, the image recording part 50 serving as a processing part supplies the ink serving as a processing material to the base material in the form of processing in the aforementioned preferred embodiment. However, the base material processing apparatus according to the present invention may include a processing part which supplies a processing material (e.g., resist solutions and various coating materials) other than the ink to the surface of the base material. Alternatively, the base material processing apparatus according to the present invention may perform processing (e.g., exposure to light for the formation of a pattern and drawing using laser) other than the supply of the processing material to the base material on the transport path of the base material.

The components described in the aforementioned preferred embodiment and in the modifications may be consistently combined together, as appropriate.

While the invention has been described in detail, the foregoing description is in all aspects illustrative and not restrictive. It is understood that numerous other modifications and variations can be devised without departing from the scope of the invention.

What is claimed is:

1. A meandering correction apparatus comprising:
a transport mechanism for transporting an elongated strip-shaped base material in a longitudinal direction thereof along a transport path;
an orientation measurement part for measuring fiber orientations of said base material in respective measurement regions on said transport path, the measurement regions being different in widthwise position from each other;
a Young's modulus calculation part for calculating Young's moduli of said base material for the respective measurement regions, based on said fiber orientations;
a meandering prediction part for predicting subsequent meandering of said base material, based on said Young's moduli, to output meandering prediction information; and
a meandering correction part for correcting the widthwise position of said base material, based on said meandering prediction information.

2. The meandering correction apparatus according to claim 1, wherein
said orientation measurement part measures said fiber orientations in three respective measurement regions different in widthwise position from each other.

3. The meandering correction apparatus according to claim 1, wherein:
said orientation measurement part measures said fiber orientations in respective measurement positions included in said measurement regions; and
said Young's modulus calculation part calculates a representative value of the fiber orientations for each of said measurement regions, and calculates said Young's modulus for each of said measurement regions, based on said representative value.

4. The meandering correction apparatus according to claim 3, wherein
said measurement positions are arranged in a width direction of said base material.

5. The meandering correction apparatus according to claim 1, wherein:
said orientation measurement part measures said fiber orientations in respective measurement positions included in said measurement regions; and
said Young's modulus calculation part calculates said Young's moduli for said respective measurement positions, based on said fiber orientations, and calculates a representative value of said Young's moduli for each of said measurement regions.

6. The meandering correction apparatus according to claim 5, wherein
said measurement positions are arranged in a width direction of said base material.

7. The meandering correction apparatus according to claim 1, wherein said meandering correction part is positioned downstream from said orientation measurement part as seen along said transport path.

8. A base material processing apparatus comprising:
a transport mechanism for transporting an elongated strip-shaped base material in a longitudinal direction thereof along a transport path;
an orientation measurement part for measuring fiber orientations of said base material in respective measurement regions on said transport path, the measurement regions being different in widthwise position from each other;
a Young's modulus calculation part for calculating Young's moduli of said base material for the respective measurement regions, based on said fiber orientations;
a meandering prediction part for predicting subsequent meandering of said base material, based on said Young's moduli, to output meandering prediction information;
a meandering correction part for correcting the widthwise position of said base material, based on said meandering prediction information; and
a processing part for performing processing on said base material on said transport path.

9. The base material processing apparatus according to claim 8, wherein
said processing part is positioned downstream from said orientation measurement part and said meandering correction part as seen along said transport path.

10. The base material processing apparatus according to claim 8, wherein
said processing part supplies a processing material to a surface of said base material.

11. A method of correcting a widthwise position of an elongated strip-shaped base material transported along a transport path to correct meandering of the base material, said method comprising the steps of:
a) measuring fiber orientations of said base material in respective measurement regions on said transport path, the measurement regions being different in widthwise position from each other;
b) calculating Young's moduli of said base material for the respective measurement regions, based on said fiber orientations;
c) predicting subsequent meandering of said base material, based on said Young's moduli, to output meandering prediction information; and
d) correcting the widthwise position of said base material, based on said meandering prediction information.

12. The method according to claim 11, wherein
said fiber orientations in three respective measurement regions different in widthwise position from each other are measured in said step a).

13. The method according to claim 11, wherein:
said fiber orientations in respective measurement positions included in said measurement regions are measured in said step a); and
said step b) includes the steps of
b-1) calculating a representative value of the fiber orientations for each of said measurement regions, and
b-2) calculating said Young's modulus for each of said measurement regions, based on said representative value.

14. The method according to claim 13, wherein
said measurement positions are arranged in a width direction of said base material.

15. The method according to claim 11, wherein:
said fiber orientations in respective measurement positions included in said measurement regions are measured in said step a); and
said step b) includes the steps of
b-1) calculating said Young's moduli for said respective measurement positions, based on said fiber orientations, and
b-2) calculating a representative value of said Young's moduli for each of said measurement regions.

16. The method according to claim 15, wherein
said measurement positions are arranged in a width direction of said base material.

17. The method according to claim 11, wherein
the widthwise position of said base material is corrected downstream from said measurement regions as seen along said transport path in said step d).
